(19) United States
(12) Patent Application Publication
(10) Pub. No.: US 2016/0108998 A1
(43) Pub. Date: Apr. 21, 2016

(54) movement converter device

(71) Applicant: Robert Bosch GmbH, Stuttgart (DE)

(72) Inventors: Raynald SPROCQ, Esbly (FR); Chris Anderson, Paris (FR)

(21) Appl. No.: 14/882,827

(22) Filed: Oct. 14, 2015

(30) Foreign Application Priority Data
Oct. 15, 2014 (FR) 145 98 68

(51) Int. Cl. F16H 19/02

(52) U.S. Cl. CPC F16H 19/02

(57) ABSTRACT

A movement converter device between a drive organ and receptor organ, including a screw with an axis of rotation, translationally fixed and rotationally driven, a nut engaging with the screw and connected in translation to the receptor organ, a concentric sleeve, coaxially surrounding the nut and fixed in rotation and translation. A connection involving a cam and a follower connects the nut and the sleeve. The cam defines the movement conversion profile.

### RELATED APPLICATION INFORMATION

The present application claims priority to and the benefit of French patent application No. 1 459 868, which was filed in France on Oct. 15, 2014, the disclosure of which is incorporated herein by reference.

### FIELD OF THE INVENTION

The present invention relates to a movement converter device that transforms an incoming rotational movement supplied by a motor into a translational movement at a receiving organ.

### BACKGROUND INFORMATION

There are believed to be a number of devices for movement conversion such as differential speeds, variators, or devices that transform a rotational movement into a linear movement, for example, axial piston pumps and rotating cylinder blocks, which are still referred to as Janney pumps (hydraulic and pneumatic mechanisms/Jacques Faisandier, Éditions Dunod, 1999).

These axial piston pumps transform an incoming rotational movement into a translational piston movement. Inclination of the rotating plate with which the piston rods make contact modifies the throughput of the pump for a given rotational speed applied at the pump's inlet. But this principle of the relative inclined plate, which can be varied to modify the throughput, only applies to pump structures or mechanisms similar to such axial piston pumps. It is a complex mechanism, which is suitable only for this use.

### SUMMARY OF THE INVENTION

An object of the invention is to provide an arrangement for transforming an incoming rotational movement, generally constant, into a variable translational movement at the outlet, in order to enable or facilitate the control of organs or actuators with a simple arrangement.

To that end, the object of the invention is a movement converter device between a motor organ and a receptor organ, characterized in that it comprises: a screw, fixed in translation and reversibly driven in rotation, a nut engaging with the screw and translationally connected to the receptor organ, a concentric sleeve, coaxially surrounding the nut and rotationally and translationally fixed, a connection by a cam and a follower between the nut and the sleeve, where one bears the cam that determines the movement conversion profile and the other element bears the follower engaged in the cam.

The device according to the invention has the advantage of being able to variably adapt the speed of translation at the outlet of the converter, based on a cam profile, to the constant rotational speed applied at the inlet of the converter. Consequently, a certain type of drive organ having precise characteristics can be easily adapted to a variety of receptor or driven organs to be controlled, the adaptation occurring through the profile given to the cam.

The operation can also be reversed if the movement between each of the two pairs of connectors is reversible, between the screw/nut threads and between the cam/follower connection. Thus, the incoming and outgoing movements can be exchanged. The same is true of the elements fixed in rotation and/or translation, which can be exchanged.

According to a particular characteristic, the cam is realized in the interior surface of the sleeve and the follower is in relief, carried by the exterior surface of the nut. This results in an especially compact realization around the converter axis. This highly compact device can easily be incorporated into an actuator, as, for example, in the many actuators controlling equipment in automobiles.

Due to the shape of the cam profile, a converter outlet can be adapted to a requested power variation during a work cycle or a work cycle of a receptor organ. For example, in a piston pump whose movement of translation of the piston is controlled by the outlet of the converter according to the invention.

The movement converter device operates cyclically, that is, for example, by a rotational movement of the motor organ in one direction for a first phase of movement at the outlet of the converter and a rotational movement of the motor organ in the opposite direction for the second phase of the return movement.

According to another advantageous characteristic, the cam is a segment of a curve alternatively traversed in one direction or another, or a continuous curve closed on itself, traversed in one direction, that is, having a loop profile such that the conversion movement is transformed into a back-and-forth translation movement of variable speed, realized by a looped conversion curve.

The present invention will be described in greater detail by using an example of the motion converter device represented in the attached drawings.

### BRIEF DESCRIPTION OF THE DRAWINGS

FIG. 1 is an axial cutaway of a motion converter device.

FIG. 2 is the evolution of the connections using a screw and cam of the converter device of FIG. 1.

### DETAILED DESCRIPTION

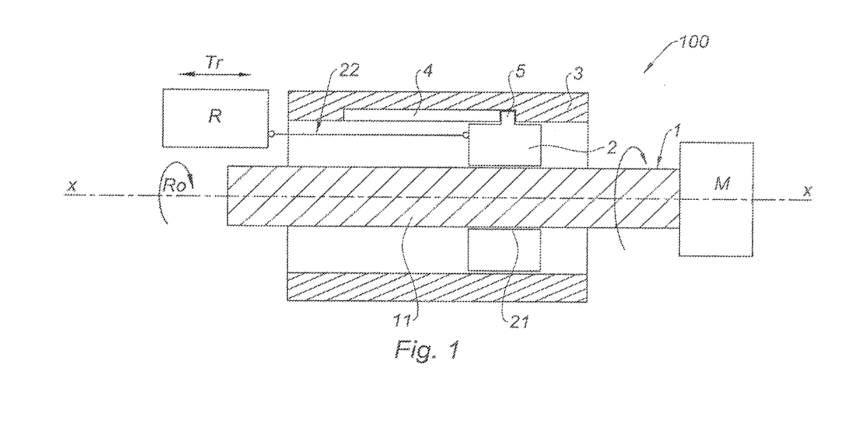

According to FIG. 1, the object of the invention is movement converter device 100 installed between drive organ M and receptor organ R. Drive organ M supplies a reversible rotational drive movement, Ro, and receptor organ R is intended to be translationally displaced (Tr), in some cases reversibly.

Converter device 100 consists of screw 1 with axis XX, translationally fixed but rotationally free. This screw 1 is rotationally driven by drive organ M. Screw 1 engages, through threads 11, with threads 21 on nut 2, translationally connected to receptor organ (R).

Nut 2 is surrounded by concentric sleeve 3, coaxial with axis XX. This sleeve 3 is rotationally and translationally fixed.

Nut 2 and sleeve 3 are connected through cam 4 and follower 5, respectively carried by either element 2, 3. In the example, nut 2 bears follower 5, and the inner surface of sleeve 3, facing nut 2, cam 4, forming the path imposed on follower 5 of nut 2. This cam 4 is, for example, machined on the inner surface of sleeve 3; it defines the movement conversion profile between the rotational movement, Ro, supplied by drive organ M, and the translational movement, Tr, of receptor organ R. Follower 5 is an organ that protrudes from the outside surface of nut 2. Nut 2 is connected to receptor R by connector organ 22, represented by a rod that transmits the longitudinal movement of displacement of nut 2 along axis XX without transmitting its rotational movement.

Depending on the direction of rotation, R0, of screw 1, nut 2 realizes a combined movement of rotation and translation or a combined reverse movement of rotation and translation. The direction of translation, Tr, applied to receptor R depends on the profile of cam 4 and the direction of rotation of screw 1.

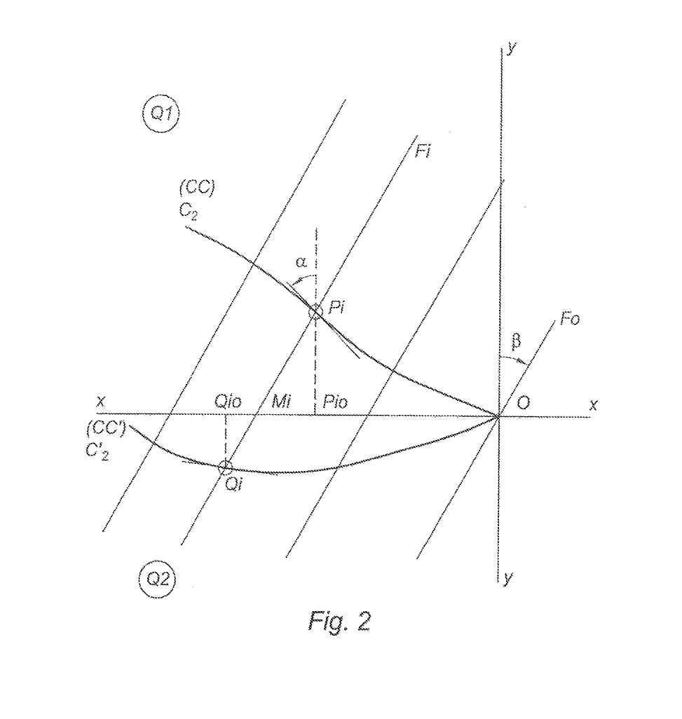

FIG. 2 is a schematic in a plane to describe the operation of movement conversion device 100. Axis XX is the axis of screw 1.

To explain its operation, we consider a theoretical nut of thickness zero, initially fixed in rotation and displaced by the rotation of screw 1. The plane of this theoretical nut cuts axis XX of screw 1 at intersection M, representing the position of this theoretical nut on axis XX. Threads 21, which, in this example, have a constant pitch, are represented, with respect to the nut, by straight line F, shown as in the plane.

Axis YY, which passes through the origin, O, of the coordinate system, can be used to identify the slope of threads 11 (F).

Cam 4 is represented by its development, CC, or CC′, corresponding to two examples, represented by any non-straight curves, to generalize the explanations. In this basic representation, the nut is not only a disc of zero thickness (direction XX) but it has interior threads 21 and exterior follower 5. The interior of the nut and its exterior are conflated, that is, separated by a null thickness in direction YY, such that this theoretical nut is finally limited to an arc having interior threads 21 engaging with threads 11 of screw 1 and, on the exterior, follower 5 engaging with cam 4.

This also means that follower 5 is, at the same time, in cam 4 and on threads 21. The threads of the screw push (or pull) nut 2 by cooperating with threads 21 and, for the purpose of explaining its operation, we consider a theoretical nut, fixed in rotation, and a free nut whose rotation is controlled or guided by the cooperation of follower 5 with cam 4.

If we assume that the two nuts are driven by the same screw 1 from origin O of axis OX:

the nut fixed in rotation is pushed by the threads of screw 1 and displaced along axis OX just as point M and the evolution (F) of the threads passing through point M

the nut, rotationally non-fixed but slaved in rotation by follower 6 in cam 4, is driven by these same threads in parallel with the fixed nut. However, because it is rotationally driven, during its translation controlled by screw 1, it makes a rotational movement in one or another direction. This rotational movement is translated by the screwing/unscrewing of the nut along threads 11 of screw 1, such that, depending on the direction of rotation thereby imposed upon the nut by being slaved, the nut will be ahead of or behind the position of the rotationally fixed nut (point M). This rotational movement is imposed by position P of follower 5, borne by the nut, on cam CC (4), which is represented by position P0 on the axis of displacement, projection of point P on that axis.

Starting from an initial position of the two nuts at the origin O (threads F0), threads F (21) “advance” along axis OX due to the rotation of screw 1.

Screw 1 simultaneously pushes:

the nut fixed in rotation, represented by point M on axis OX (because the fixed nut can only move along axis OX) and

the nut driven by follower 5 on cam 4, that is, the nut represented by its follower 5, which is point P on curve CC.

To summarize, curve CC imposes upon the nut pushed by the screw a movement of translation along axis OX other than the movement imposed upon the nut that is rotationally fixed (M).

Simply put, the engagement of nut 2 with screw 1 displaces nut 2 and, therefore, its threads 21, that is, its evolution F on FIG. 2.

In the above theoretical case of a nut of zero thickness, follower 5 is found by “transparency” on threads 21 and by mechanical engagement with cam 4.

The device according to the invention, therefore, enables movements to be converted. This conversion is the result of the shape of cam 4 (CC). More specifically, in the example of curve CC, the nut's rotation generates a “negative” translation component that is subtracted from the “positive” component produced by threads F alone (11) on screw 1.

With respect to curve CC′, the nut makes “positive” rotations that generate a “positive” translation component that is added to the positive translation component generated by threads F on screw 1.

The movement converter according to the invention converts movement for a certain displacement. This movement converter does not operate continuously. It can only operate reversibly because the length of the device is necessarily limited and, at the end of travel of follower 5 on cam 4, the movement must be reversed to return, for example, to origin O on curve CC or to an intermediate position. This movement converter is suitable for devices that operate occasionally or periodically and that require movement variation.

What is claimed is:

1. A movement converter device between a drive organ and a receptor organ, comprising:
a screw having an axis of rotation, translationally fixed and reversibly driven in rotation;
a nut engaging with the screw and connected in translation to the receptor organ; and
a concentric sleeve coaxially surrounding the nut and fixed in rotation and translation;
wherein there is a connection by a cam and a follower between the nut and the sleeve one of which carries the cam defining the movement conversion profile and the other element carrying the follower engaged with the cam.

2. The movement converter device of claim 1, wherein the cam is in the sleeve and the follower is borne by the nut.

3. The movement converter device of claim 1, wherein the cam includes a segment of a curve.
